(19) United States
(12) Patent Application Publication
(10) Pub. No.: US 2006/0294166 A1
(43) Pub. Date: Dec. 28, 2006

(54) ARRANGEMENT AND METHOD FOR GARBAGE COLLECTION IN A COMPUTER SYSTEM

(76) Inventors: Sam Borman, Ampleforth (GB); Saket Rungta, Jaipur (IN); Andy Wharmby, Romsey (GB)

Correspondence Address: IBM CORPORATION;INTELLECTUAL PROPERTY LAW, 11400 BURNET ROAD, AUSTIN, TX, 78758, US

(21) Appl. No.: 11/278,866

(22) Filed: Apr. 6, 2006

(30) Foreign Application Priority Data
Jun. 23, 2005 (GB) 0512809.5

(51) Int. Cl. G06F 17/30

(52) U.S. Cl. 707/206

(57) ABSTRACT

An arrangement and method (400) for optimising stop-the-world sweep time in garbage collection by using an additional bit-vector meta-mark-map (300) whose bits respectively map onto groups of bits of in a bit-vector mark-map (200). This meta-mark-map enables a scan to be made much faster, in particular on large heaps.

### FIELD OF THE INVENTION

This invention relates to garbage collection in a managed runtime computer environment.

### BACKGROUND OF THE INVENTION

In the field of this invention it is known that garbage collection (e.g., as relied on in the Java (Java and all Java-based trademarks are trademarks of Sun Microsystems, Inc. in the United States, other countries, or both) programming language) is a part of a programming language's runtime system, or an add-on library, perhaps assisted by the compiler, the hardware, the operating system, or any combination of the three, that automatically determines what memory a program is no longer using, and recycles it for other use. It is also known as “automatic storage (or memory) reclamation”.

Garbage collection is preferred to manual memory management, which is (programmer-)time consuming, and error prone, since most programs still contain leaks (particularly programs using exception-handling and/or threads). The benefits of garbage collection are increased reliability, decoupling of memory management from class interface design, and less developer time spent chasing memory management errors. However, garbage collection is not without its costs, including performance impact, pauses, configuration complexity, and nondeterministic finalization.

A common method of garbage collection is mark-sweep, where allocated memory is marked and a collector sweeps the heap and collects unmarked memory for re-allocation. An entire collection may be performed at once while the user program is suspended (so-called ‘stop-the-world’ collection). Alternatively, the collector may run incrementally (the entire heap not being collected at once, resulting in shorter collection pauses), or a user program may run concurrent collectors.

However, these approaches have the disadvantages that the sweep phase of garbage collection can take a significant part of the pause time (greater than 50%), whereas Concurrent Sweep (a known solution to this problem) has the drawback of decreasing throughput.

A need therefore exists for garbage collection wherein the above mentioned disadvantage(s) may be alleviated.

### DISCLOSURE OF THE INVENTION

In accordance with a first aspect of the present invention there is provided an arrangement, for use in garbage collection in a computer system, as claimed in claim 1.

In accordance with a second aspect of the present invention there is provided a method, for use in garbage collection in a computer system, as claimed in claim 10.

### BRIEF DESCRIPTION OF THE DRAWING(S)

One arrangement and method for optimising garbage collection stop-the-world sweep time utilising the present invention will now be described, by way of example only, with reference to the accompanying drawings, in which:

FIG. 1 shows a block schematic diagram illustrating a memory heap, a mark-map and a meta-mark-map used in a preferred embodiment of the present invention; and

FIG. 2 shows a block schematic diagram illustrating steps of a method of garbage collection using the memory heap, mark-map and meta-mark-map shown in FIG. 1; and

FIG. 3 shows a block schematic diagram illustrating a collector for performing the garbage collection method shown in FIG. 2.

### DESCRIPTION OF PREFERRED EMBODIMENT(S)

As is well known, a mark-map is typically is used to determine live/dead objects in the memory heap in garbage collection in a computer system, e.g., a Java Virtual Machine.

The mark-map is a bit-vector such that there is 1 bit for every object_grain_size bytes of heap, i.e., 1 byte (8 bits) for each (8* object_grain_size) bytes of heap. Thus, the size of the mark-map in bytes is:
((heap size in bytes)/(8*object_grain_size)).

For example, assuming object_grain_size=4 bytes and a heap of 1000 MB in size, the mark-map will have a size of 1000 MB/(8*4)=31.250 MB.

Conventionally, in garbage collection using such a mark-map, the majority of stop-the-world sweep time is spent in touching and walking over this large mark-map (31.250 MB).

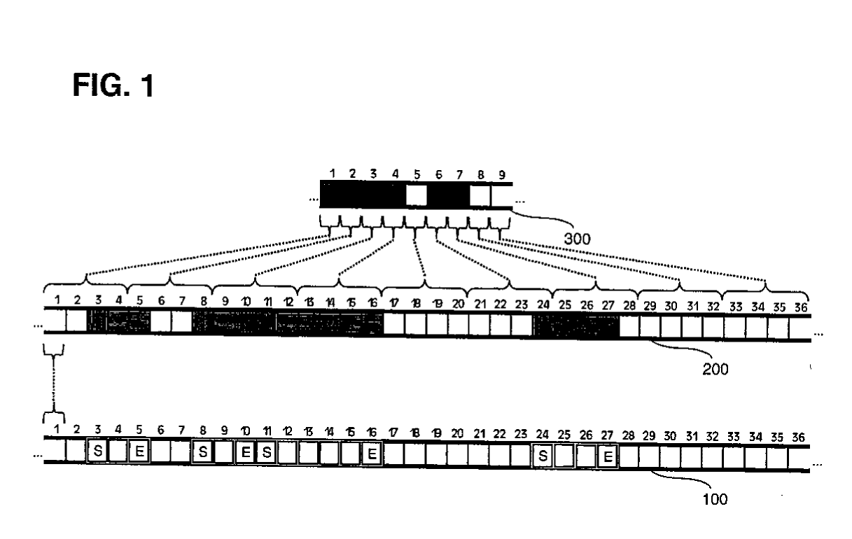

Referring now to FIG. 1, the present invention is based upon a meta-mark-map, another bit-vector such that each meta-mark-map bit maps to N mark-map bits, effectively giving a compression of N:1. The illustration of FIG. 1 shows part of a memory heap 100, mark-map 200 and meta-mark-map 300.

As illustrated in FIG. 1, in the heap 100 each unit or box represents A bits of memory, where A=(8*object_grain_size). Each unit or box shown with a double-line border represents part of a marked or set object, with the start and end of an object being indicated respectively by a box labelled ‘S’ and a box labelled ‘E’. In the mark-map 200, each unit or box represents 1 bit and maps to a respective group of A bits of the memory heap. In the meta-mark-map 300, each unit or box represents 1 bit and maps to a respective group of N bits of the mark-map 200; in the present illustration N=4 is chosen for example.

In the meta-mark-map 300 and the mark-map 200: a hatched box represents a set bit and un-hatched box represents an unset bit. Vertical hatching indicates a physically set bit, and horizontal hatching indicates a logically set bit, using the following scheme. In the present example, a bit is set (here called a physical bit) only for the start of an object in the mark-map (e.g., bit 3 in FIG. 1 for the first object), and the other bits for the object represented in the mark-map are termed ‘logically set’. In the present example, while processing the mark-map, bits 4 and 5 are inferred to be set for the first object, by looking at the meta-data for the object represented by bit 3. This is better for performance than physically setting all the corresponding bits in the mark-map (i.e., setting bits 3, 4 and 5). However, it will be understood that this scheme of physical and logical setting of mark-maps is not an absolute requirement and that some garbage collectors may alternatively physically set bits 3, 4, 5.

Thus, it can be seen that the marked or set objects depicted in boxes 1-36 of the heap 100 as illustrated in FIG. 1 produces a pattern of set bits depicted by the hatching of boxes 1-36 of the mark-map 200 as illustrated. Further, it can be seen that the marked or set objects depicted in boxes 1-36 of the mark-map 200 as illustrated in FIG. 1 produces a pattern of set bits depicted by the hatching of boxes 1-9 of the meta-mark-map 300 as illustrated.

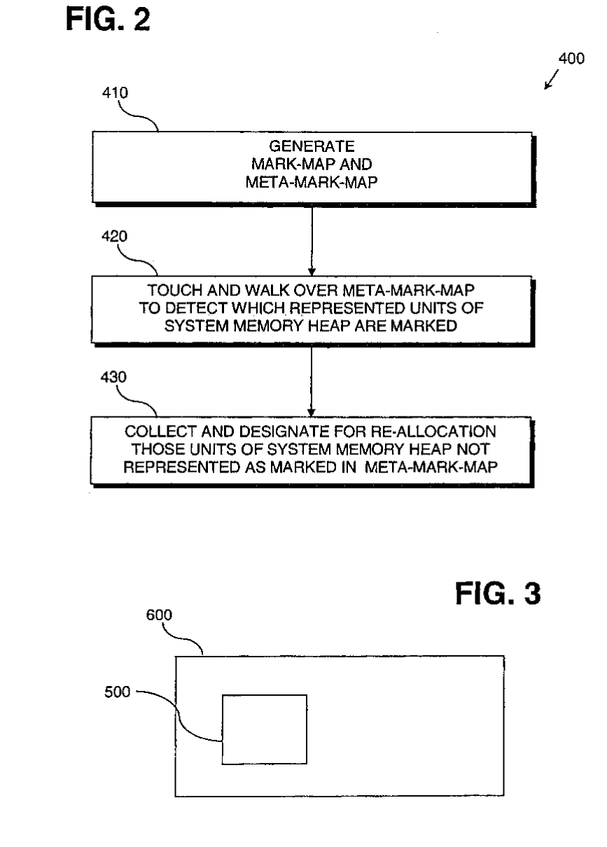

Referring now also to FIG. 2, it will be understood that a method of garbage collection 400 using the meta-mark-map proceeds as follows:
Firstly, at step 410, the mark-map 200 and the meta-mark-map 300 are generated;
Secondly, at step 420, the meta-mark-map 300 is touched and walked over to detect which of the represented units of the system memory heap 100 are marked; and
Thirdly, at step 430, those units of the system memory heap 100 not represented as marked in the meta-mark-map 300 are collected and designated for re-allocation by a memory controller (not shown) in known manner.

Referring now also to FIG. 3, it will therefore be understood that the meta-mark-map 300 is readily used in garbage collection by a collector 500, running in Java software on a processor 600, walking the meta-mark-map (rather than walking the mark-map 200 as heretofore), and collecting for re-allocation those units of the system memory heap 100 not represented as marked in the meta-mark-map.

In practice, in order to use the meta-mark-map 300, there must be decided:
A a suitable value for N (in the illustrated example N=4 is chosen),
B the meaning of set and unset bits in the meta-mark-map, and
C how the meta-mark-map can be built for relatively negligible cost (cost in terms of pause time).

Concerning decision A (the value for N), an optimal value for N would be:

((minimum_size_for_a_freelist_candidate in bytes/2)/object_grain_size in bytes).

For example, assuming minimum_size_for_a_freelist_candidate=512 bytes for the earlier example, this would give N=((512/2)/4)=64. This would give a meta-mark-map of size (31.250 MB/64)=0.488 MB.

Concerning decision B (the meaning of set and unset bits in the meta-mark-map), the following meaning is chosen:
All meta-mark-map bits are set corresponding to a single object in the heap. A set meta-mark-map bit need not be set again.
One unset bit (with adjoining set bits, if any) may or may not be part of a free chunk of 512 bytes or more (two, or more, consecutive unset bits will be a free chunk of 512 bytes or more.)
For each run of one or more consecutive unset bits in the meta-mark-map, mark-map bits are scanned for the preceding and following set bit (if any) to compute free chunk size. Set bits are ignored.

Concerning decision C (building meta-mark-map for relatively negligible cost—in terms of pause time):
The initialisation of, and subsequent updates to, a meta-mark-map has some cost. It is important to ensure that this cost is negligible otherwise benefits to this cost will be lost.
The majority of the work (e.g., populating the mark-map and the meta-mark-map) can be done during concurrent marking phase for free (free from pause time perspective, producing negligible throughput hit).
Remaining cleanup work can be done in final concurrent collection (in conventional phases of final card cleaning and stop-the-world mark) for a relatively negligible cost.
The footprint overhead is assumed to be negligible. For example, a 1000 MB heap with 31.250 MB mark-map overhead will have an added overhead of 0.488 MB.

It will be understood that the benefits of using the meta-mark-map 300 can be summarised as follows:

The meta-mark-map 300 is much smaller, and so can be touched and walked over much more quickly, than the mark-map 200. In an ideal scenario, 0.488 MB is much less memory to touch and walk over than 31.250 MB; in a realistic scenario, overall memory touched and walked is significantly less than 31.250 MB.

The meta-mark-map 300 can be read one word at a time (like mark-map 200 heretofore). This is an added advantage, since N*object_grain_size*word_size bytes of heap can be scanned with a single register comparison operation (or 64*4*32 bytes=8,096 bytes in the earlier example for a 32-bit system with word_size=32); this compares to a scan of (object_grain_size*word_size) with a single register comparison operation for the existing implementation (or 4*32 bytes=128 bytes in the earlier example). Therefore, a complete scan of heap needs much fewer register comparison operations.

The main benefit will be for large heaps, but performance improvements should also be seen on smaller heaps.

It will be understood that a further optimisation would be to have a hierarchy of meta-mark maps depending on the size of the heap, units of a mark-map higher in the hierarchy representing respectively pluralities of units of a mark-map lower in the hierarchy.

It will also be understood that a further optimisation would use the meta-mark-map scheme described above for stop-the-world mark phase when running without concurrent functionality.

It will be appreciated that the novel garbage collection scheme using the meta-mark-map described above is carried out in software running on a processor in one or more computers, and that the software may be provided as a computer program element carried on any suitable data carrier (not shown) such as a magnetic or optical computer disc.

It will be understood that further modifications to the example described above may be made by a person of ordinary skill in the art without departing from the scope of the present invention.

1. An arrangement for use in garbage collection in a computer system, the arrangement comprising:
a meta-mark-map comprising a plurality of units each respectively indicating status of a predetermined plurality of units of a mark-map, wherein the plurality of units of the mark-map respectively indicate allocation status of units of memory.

2. The arrangement of claim 1, further comprising means for collecting for allocation units of memory indicated as unallocated in the meta-mark-map.

3. The arrangement of claim 1 wherein the predetermined plurality is numerically equal to the quotient of half predetermined minimum size for a freelist candidate and predetermined object grain size.

4. The arrangement of claim 2 wherein:
meta-mark-map bits are arranged to be set corresponding to a single memory object;
at least two meta-mark-map bits are arranged to indicate a free group of units of memory; and
for each run of one or more consecutive unset meta-mark-map bits, mark-map bits are arranged to be scanned for a possible preceding set bit and a possible following set bit to compute group size of free memory units.

5. The arrangement of claim 2, wherein the mark-map and the meta-mark-map are arranged to be populated substantially in a concurrent marking phase; and remaining cleanup work is arranged to be performed substantially in final concurrent collection.

6. The arrangement of claim 2, wherein the meta-mark-map is arranged to be read one word at a time.

7. The arrangement of claim 2, wherein the arrangement comprises a hierarchy of a plurality of meta-mark-maps, units of a mark-map higher in the hierarchy representing respectively pluralities of units of a mark-map lower in the hierarchy.

8. The arrangement of claim 2 wherein the arrangement is arranged to be used in a stop-the-world mark phase when running without concurrent functionality.

9. The arrangement of claim 2, wherein the computer system comprises a Java computer system.

10. The arrangement of claim 9 wherein the computer system comprises a Java Virtual Machine.

11. A method for use in garbage collection in a computer system, the method comprising:
generating a meta-mark-map comprising a plurality of units each respectively indicating status of a predetermined plurality of units of a mark-map, wherein the plurality of units of the mark-map respectively indicate allocation status of units of memory.

12. The method of claim 11, further comprising the step of: collecting for allocation units of memory indicated as unallocated in the meta-mark-map.

13. The method of claim 11, wherein the predetermined plurality is numerically equal to the quotient of half predetermined minimum size for a freelist candidate and predetermined object grain size.

14. The method of claim 12 wherein:
meta-mark-map bits are set corresponding to a single memory object;
at least two meta-mark-map bits indicate a free group of units of memory; and
for each run of one or more consecutive unset meta-mark-map bits, mark-map bits are scanned for a possible preceding set bit and a possible following set bit to compute group size of free memory units.

15. The method of claim 12, wherein the method is performed substantially in a concurrent marking phase; and remaining cleanup work is performed substantially in final concurrent collection.

16. The method of claim 12, wherein the meta-mark-map is read one word at a time.

17. The method of claim 12, wherein the step of generating a meta-mark-map comprises providing a hierarchy of a plurality of meta-mark-maps, units of a mark-map higher in the hierarchy representing respectively pluralities of units of a mark-map lower in the hierarchy.

18. The method of claim 12, wherein the method is performed in a stop-the-world mark phase when running without concurrent functionality.

19. The method of 11 wherein the computer system comprises a Java computer system and a Java Virtual Machine.

20. (canceled)

21. A computer program element stored on a data carrier and comprising computer program means for instructing a computer to perform substantially the step of generating a meta-mark-map comprising a plurality of units each respectively indicating status of a predetermined plurality of units of a mark-map, wherein the plurality of units of the mark-map respectively indicate allocation status of units of memory.

22. (canceled)

23. (canceled)
